(19) United States
(12) Patent Application Publication
(10) Pub. No.: US 2025/0039916 A1
(43) Pub. Date: Jan. 30, 2025

(54) AUTONOMOUS SELECTION OF BASE STATIONS BASED ON COVERAGE AND INTERFERENCE ESTIMATION IN A HYBRID MOBILE NETWORK ENVIRONMENT

(71) Applicant: Charter Communications Operating, LLC, St. Louis, MO (US)

(72) Inventor: Pareshkumar Panchal, Highlands Ranch, CO (US)

(21) Appl. No.: 18/359,608

(22) Filed: Jul. 26, 2023

(51) Int. Cl. H04W 72/542; H04B 17/318; H04B 17/391; H04W 48/20

(52) U.S. Cl. CPC H04W 72/542; H04B 17/318; H04B 17/3913; H04W 48/20

(57) ABSTRACT

A plurality of candidate locations are identified for deployment of a wireless base station within a particular area. A set of information is evaluated with a signal prediction model to obtain predicted signal information comprising a respective plurality of signal strength predictions associated with deployment of the wireless base station at the plurality of candidate locations, wherein the set of information comprises signal strength measurements reported by wireless devices while located within either (a) the particular area or (b) another area similar to the particular area. based on the predicted signal information, a particular candidate location of the plurality of candidate locations is determined for deployment of the wireless base station.

### BACKGROUND

Hybrid Mobile Networks (HMNs) are wireless networks operated by multiple network service providers. HMNs reduce wireless coverage gaps by facilitating wireless resource sharing between network service providers. For example, assume that a wireless device receives wireless network services from a first network service provider, and that the wireless device is out of range of any base stations belonging to the first network service provider. If the first network service provider is part of an HMN, the wireless device can access a base station belonging to some other wireless provider that is also part of the HMN. In this manner, coverage gaps can be reduced for all network service providers of an HMN.

### SUMMARY

Implementations described herein provide for autonomous selection of base station deployment locations. In particular, candidate locations for deployment of base stations can be identified. Information related to the candidate locations (e.g., height, coordinates, signal strength measurements, predicted signal strength metrics, etc.) can be evaluated with a signal prediction model to obtain predicted signal information. Based on the predicted signal information, a particular candidate location can be determined for deployment of the wireless base station.

In one implementation, a method is provided. The method includes identifying, by a computing system comprising one or more processor devices, a plurality of candidate locations for deployment of a wireless base station within a particular area. The method further includes evaluating, by the computing system, a set of information with a signal prediction model to obtain predicted signal information comprising a respective plurality of signal strength predictions associated with deployment of the wireless base station at the plurality of candidate locations, wherein the set of information comprises signal strength measurements reported by wireless devices while located within either (a) the particular area; or (b) another area similar to the particular area. The method further includes, based on the predicted signal information, determining, by the computing system, a particular candidate location of the plurality of candidate locations for deployment of the wireless base station.

In another implementation, a computing system is provided. The computing device includes a memory, and a processor device coupled to the memory. The processor device is to identify a plurality of candidate locations for deployment of a wireless base station within a particular area. The processor device is further to evaluate a set of information with a signal prediction model to obtain predicted signal information comprising a respective plurality of signal strength predictions associated with deployment of the wireless base station at the plurality of candidate locations, wherein the set of information comprises signal strength measurements reported by wireless devices while located within either (a) the particular area; or (b) another area similar to the particular area. The processor device is further to, based on the predicted signal information, determine a particular candidate location of the plurality of candidate locations for deployment of the wireless base station.

In another implementation, a non-transitory computer-readable storage medium is provided. The non-transitory computer-readable storage medium includes executable instructions to cause one or more processor devices to identify a plurality of candidate locations for deployment of a wireless base station within a particular area. The instructions further cause the processor device to evaluate a set of information with a signal prediction model to obtain predicted signal information comprising a respective plurality of signal strength predictions associated with deployment of the wireless base station at the plurality of candidate locations, wherein the set of information comprises signal strength measurements reported by wireless devices while located within either (a) the particular area; or (b) another area similar to the particular area. The instructions further cause the processor device to, based on the predicted signal information, determine a particular candidate location of the plurality of candidate locations for deployment of the wireless base station.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for implementing autonomous selection of base station deployment locations according to some implementations of the present disclosure.

FIG. 2 illustrates a signal strength coverage map and interference coverage map for a base station deployed to a candidate location within a particular area according to some implementations of the present disclosure.

FIG. 3 is a data flow diagram for leveraging the base station location determinator of FIG. 1 to perform autonomous selection of base station deployment locations according to some implementations of the present disclosure.

FIG. 4 is a flowchart of a method for autonomous selection of base station deployment locations according to some implementations of the present disclosure.

FIG. 5 is a block diagram of the computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Hybrid Mobile Networks (HMNs) are wireless networks operated by multiple network service providers. HMNs reduce wireless coverage gaps by facilitating wireless resource sharing between network service providers. For example, assume that a wireless device receives wireless network services from a first network service provider, and that the wireless device is out of range of any base stations belonging to the first network service provider. If the first network service provider is part of an HMN, the wireless device can access a base station belonging to some other wireless provider that is also part of the HMN. In this manner, coverage gaps can be reduced for all network service providers of an HMN.

HMNs have gained importance in recent years due to the development of increasingly fast wireless technology standards. In particular, the speed and bandwidth capabilities of wireless networks provided using Fifth Generation (5G) New Radio (NR) base stations far exceeds that of prior generations. 5G NR base stations are generally more efficient than Fourth Generation (4G) Long-Term Evolution (LTE) base stations on a per-frequency basis. However, much of the increased speed and bandwidth of 5G NR base stations can be attributed to the utilization of higher frequencies than those used with 4G LTE.

Although utilization of higher frequencies can increase bandwidth, it can also substantially decrease coverage range depending on signal wavelength. For example, a base station deploying FR1 (frequencies <6 GHz) on 4G vs base stations deploying FR2 (frequencies >6 GHz) will have different cell coverage areas. Indeed, the rollout of 5G or 6G networks has required the installation of substantially more base stations than required for the rollout of 4G LTE.

When building network infrastructure for previous network generations, such as 4G LTE, it was not prohibitively difficult for network service providers to manually determine the placement of base stations due to the relatively low number of base stations required. To do so, network service providers historically sent teams to visit field areas, complete feasibility surveys for certain locations, gather relevant information, and convey the information to engineering teams to determine the final locations of wireless base stations.

However, it becomes quickly apparent that such an approach is unfeasible when used to determine the final locations of 5G base stations. For example, higher-range frequencies, such as those above 3 Ghz, generally require 15-20 base stations per square kilometer. As such, a 1000 square kilometer area (e.g., roughly the size of New York City) would require 15,000 base stations. Selecting 15,000 base stations manually would be prohibitively expensive and would require years to complete. In turn, such a delay in building network infrastructure would substantially reduce available network bandwidth and speed for wireless devices in the area.

Accordingly, implementations of the present disclosure propose autonomous base station selection in a hybrid mobile network environment. More specifically, a plurality of candidate locations (e.g., empty lots for tower placement, tops of buildings, indoor locations, etc.) can be identified for deployment of a wireless base station within a particular area (e.g., a city, a town, a portion of a city/town, a county, a particular geographic region, a building, etc.)

A set of information that indicates various features of the particular area (e.g., building information, terrain information, signal strength measurements within the area, etc.) can be evaluated with a signal prediction model to obtain predicted signal information. Additionally, the set of information can include signal strength measurements reported by wireless communication devices while located within either (a) the particular area or (b) some area similar to the particular area. For example, assume that a first network service provider and a second network service provider operate a Hybrid Mobile Network (HMN). Further assume that the second network service provider has expanded to the particular area while the first network service provider has yet to expand to the area. The first network service provider can obtain signal strength measurements from wireless devices that are served by the base stations operated in the particular area by the second network service provider.

The predicted signal information can include signal strength predictions for each of the candidate locations. Based on the predicted signal information, a particular candidate location can be determined for deployment of the wireless base station. In such fashion, base station deployment locations can be autonomously selected, thus eliminating a major inefficiency that can cause substantial delays in building wireless network infrastructure.

Implementations of the present disclosure provide a number of technical effects and benefits. As one example technical effect and benefit, manual selection of base station deployment locations is inefficient and causes long delays when building out network infrastructure, which in turn substantially reduces wireless network bandwidth and speeds within certain areas. However, implementations of the present disclosure can autonomously determine locations for base station deployment with a geographic area. By substantially reducing the quantity of time required to determine base station deployment locations, implementations of the present disclosure obviate the inefficiencies associated with manual determination of deployment locations.

As another example technical effect and benefit, manual determination of deployment locations is often sub-optimal. In particular, such wide-scale undertakings are prohibitively difficult, if not impossible, to complete without introducing substantial human-caused errors. For example, a simple translation error could result in a base station being placed in a location that occludes signaling to and from the base station, leading to sub-optimal performance. Additionally, the number of deployable base stations is often constrained by the costs associated with base station deployment. As such, sub-optimal deployment of multiple base stations can lead to substantial network performance losses. However, implementations of the present disclosure eliminate vectors for human error while also determining an optimal location for each base station in a manner that maximizes coverage and network performance.

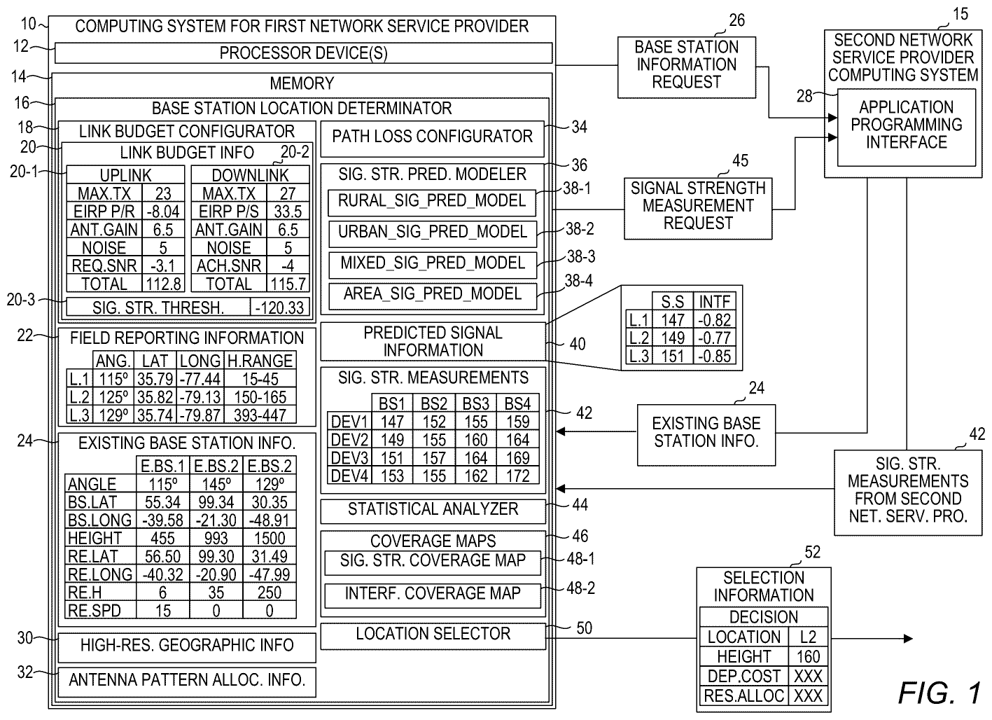

FIG. 1 is a block diagram of an environment suitable for implementing autonomous selection of base station deployment locations according to some implementations of the present disclosure. A computing system 10 includes processor device(s) 12 and memory 14. In some implementations, the computing system 10 may be a computing system that includes multiple computing devices. Alternatively, in some implementations, the computing system 10 may be one or more computing devices within a computing system that includes multiple computing devices. Similarly, the processor device(s) 12 may include any computing or electronic device capable of executing software instructions to implement the functionality described herein.

The memory 14 can be or otherwise include any device(s) capable of storing data, including, but not limited to, volatile memory (random access memory, etc.), non-volatile memory, storage device(s) (e.g., hard drive(s), solid state drive(s), etc.). In some implementations, the memory 14 can include a containerized unit of software instructions (i.e., a “packaged container”). The containerized unit of software instructions can collectively form a container that has been packaged using any type or manner of containerization technique.

Such a containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

As described herein, a “network service provider” generally refers to an entity that maintains wireless network infrastructure for the purpose of providing wireless network services. For example, a network service provider may maintain thousands of 5G NR base stations to provide a nationwide wireless service. In some implementations, a network service provider may not directly “own,” or “maintain,” the network infrastructure utilized by the network service provider to provide wireless services. For example, one network service provider may own and deploy its own network infrastructure to provide wireless services, while another network service provider may lease existing network infrastructure to provide wireless services.

The computing system 10 can be a computing system belonging to, or otherwise associated with, a first network service provider. Similarly, a second network service provider computing system 15 can belong to, or otherwise be associated with, a second network service provider different than the first network service provider. The first network service provider and the second network service provider can collectively operate an HMN. As described previously, network service providers that operate an HMN generally share network infrastructure (e.g., base stations, etc.) to collectively reduce coverage gaps for devices that subscribe to wireless services. As such, wireless communication devices that subscribe to wireless network services from the first network service provider may utilize base stations associated with the second network service provider when base stations associated with the first network service provider are unavailable. In this manner, signal strength measurements from wireless communication devices can be received by the first network service provider for an area in which the first network service provider has not yet installed network infrastructure.

The memory 14 of the computing system 10 can include a base station location determinator 16. The base station location determinator 16 can be a collection of software and/or hardware resources that processes information associated with a particular area to identify optimal locations for base stations within the particular area.

An “area,” as described herein, generally refers to a demarcated space in which base stations and other network infrastructure are to be deployed. Although an “area” usually refers to a larger geographic area, such as a city, neighborhood (e.g., Manhattan, Queens, etc.), state, country, etc., implementations of the present disclosure can determine base station locations within any type or manner of area, such as a stadium, office building, school, campus, national park, body of water, etc. In some implementations, an area may refer to a virtualized area, or three-dimensional representation of an area. For example, implementations of the present disclosure may be utilized to determine locations for simulated network infrastructure within a virtual environment.

Additionally, it should be noted that, although implementations of the present disclosure are discussed primarily within the context of base station deployment locations, implementations of the present disclosure can be utilized to determine the deployment of any type or manner of network infrastructure, network devices, network resources, etc. For example, rather than determining base station deployment locations generally, implementations of the present disclosure may be leveraged to determine specific locations for towers which hold one (or more) base stations. For another example, implementations of the present disclosure may be leveraged to determine specific locations for other devices utilized to provide network services, such as fiber optic cable lines, switches, repeaters, Optical Network Terminals (ONTs), Optical Network Units (ONUs), etc.

The base station location determinator 16 can include a link budget configurator 18. The link budget configurator 18 can determine a link budget for wireless services provided within the area. A link budget generally refers to the measurement of the total transmitted power in a wireless networking system, including all gains and losses. A link budget can also refer to the total transmitted power of a particular communication link, such as a 5G NR base station. In other words, a link budget can “quantify” the performance of a communication link.

The link budget configurator 18 can determine a link budget information 20. The link budget information 20 can include uplink budget information 20-1, a downlink budget information 20-2, and a signal strength threshold information 20-3. The uplink budget information 20-1 can include a link budget for uplink transmissions to the wireless base station to be deployed. The uplink link budget, which is also known as “uplink path loss,” can be determined based on the transmit power of the receiver wireless device and other performance-related metrics of the base station and/or the receiver device. For example, the uplink link budget may be calculated as: ((estimated transmit power of receiver device)+(antenna gain)−(other losses)−(receiver sensitivity)+(receiver antenna gain (base station))+/−(additional gain/loss)).

Similarly, the downlink budget information 20-2 can include a link budget for downlink transmissions from the wireless base station to be deployed. The downlink link budget, which is also known as “downlink path loss,” can be determined based on the transmit power of the base station to be deployed and other performance-related metrics of the base station and/or the receiver device. For example, the downlink link budget may be calculated as: ((estimated transmit power of base station)+(antenna gain)−(other losses)+(receiver sensitivity)+(receiver antenna gain (device))+/−(additional gain/loss)). In some implementations, receiver sensitivity can differ between uplink and downlink connections.

The signal strength threshold information 20-3 can include a minimum receiver signal strength. The minimum receiver signal strength can be determined based on the uplink link budget and the downlink link budget included in the uplink budget information 20-1 and the downlink budget information 20-2, respectively. In particular, a limited link path loss can be calculated by determining the minimum of the uplink link budget and the downlink link budget. The signal strength threshold can then be calculated as: ((transmit power)+(antenna gain)−(limited link pathloss)).

As an example, assume that the uplink budget information 20-1 indicates the following:
User Equipment (UE) (i.e., a wireless device) Transmit
   Max transmission power: 23 dBm
   Transmission Antenna Gain: 0 dBi
   User Effective Isotropic Radiated Power (EIRP): 23 dBm
   EIRP per resource element−8.04 dBm
GNodeB Receive
   Antenna Gain: 6.5 dBi
   Noise Figure: 5 dB
   Thermal Noise Floor/SC: −129.2 dBm
   Receiver Noise Floor: −124.2 dBm
   Required Signal-to-Interference Plus Noise Ratio (SINR): −3.1 dB
   Receiver Sensitivity: −127.3 dBm
   Body Loss: 3.0 dB
   Interference Margin: 3.0 dB
   Fade Margin: 7 dB
      Using the calculation for uplink link budget described previously, a total uplink link budget/“path loss” of 112.8 dB can be determined.

As another example, assume that the downlink budget information 20-2 indicates the following:
GNodeB Transmit
   Max transmission power: 27 dBm
   Antenna Gain: 6.5 dBi
   EIRP per sector: 33.5 dBm
   EIRP per resource element: 2.46 dBm
UE Receive
   Antenna Gain: 0 dBi
   Noise Figure: 5 dB
   Thermal Noise Floor/SC: −129.2 dBm
   Receiver Noise Floor: −124.2 dBm
   Achieved SINR: −4 dB
   Receiver Sensitivity: −128.2 dBm
   Body Loss: 3.0 dB
   Interference Margin: 5.0 dB
   Fade Margin: 7 dB
      Using the calculation for downlink link budget described previously, a total downlink budget/“path loss” of 115.7 dB can be determined. Based on the uplink link budget of 112.8 and the downlink link budget of 115.7, a signal strength threshold of −120.33 dB can be determined.

The base station location determinator 16 can include field reporting information 22. The field reporting information 22 can include records of available angles, azimuths, heights for antenna installation, latitudes and longitudes of buildings, terrain features, etc., and other information descriptive of various characteristics of the particular area. In some implementations, the field reporting information 22 can, at least in part, be manually gathered by surveyors working within the particular area. Additionally, or alternatively, in some implementations, the field reporting information can be obtained via analysis of satellite imagery, third party surveyors, historic geological information, etc.

In particular, the field reporting information 22 can include relevant information for each of a plurality of candidate locations to which the base station can be deployed. To follow the depicted example, for a first candidate location L.1, the field reporting information 22 can indicate an angle of 115°, a latitude of 35.79, a longitude of −77.44, and a possible height range of 15-45 feet for deployment of the base station.

The base station location determinator 16 can include existing base station information 24. The existing base station information 24 can include configuration information and/or location information for existing live base stations. Additionally, in some implementations, the existing base station information 24 can include similar information for wireless devices receiving transmissions from the existing base stations. For example, the existing base station information 24 can include antenna locations, antenna height, receiver height, receiver speed, receiver location, etc. In some implementations, the existing base station information 24 can be iteratively updated as additional information is received from existing base stations.

In some implementations, some (or all) of the existing base stations from which the existing base station information 24 is obtained can be base stations associated with a network service provider different than the network service provider associated with the computing system 10. For example, if the existing base stations are associated with the second network service provider, the computing system 10 can provide a base station information request 26 to the second network service provider computing system 15 via an application programming interface (API) 28. In response, the second network service provider computing system 15 can provide existing base station information 24 to the computing system 10.

The base station location determinator 16 can include high-resolution geographic information 30 for the particular area. The high-resolution geographic information 30 can describe terrain located within the particular area, dimensions of buildings within the particular area, transportation networks within the particular area, etc. The high-resolution geographic information 30 can be obtained from a variety of sources, such as satellite imagery providers, governmental entities (e.g., entities that store blueprints and/or dimensions for buildings, etc.), geological surveys, historical area information, transportation service providers, etc.

In some implementations, the high-resolution geographic information can be updated based on planned construction. For example, the high-resolution geographic information 30 can be updated based on the dimensions of accepted construction proposals for the particular area (e.g., building plans to build a particular skyscraper in the next ten years). In this manner, the high-resolution geographic information 30 can be leveraged to avoid scenarios in which a base station deployed to a candidate location is subsequently blocked once construction of the building is complete.

The base station location determinator 16 can include antenna pattern allocation information 32. The antenna pattern allocation information 32 can be a data structure, such as a two-dimensional array, that defines gain and/or attenuation factors between 0 and 360 degrees at 1-degree intervals. It can include both horizontal and vertical planes, and can store information for both the transmitter and the receiver.

The base station location determinator 16 can include a path loss configurator 34. The path loss configurator 34 can include sets of parameters for variable configuration in order to estimate path loss. As an example, the path loss configurator 34 can include parameters for type of base station, antenna configuration, indoor placement, outdoor placement, etc. In some implementations, the sets of parameters stored by the path loss configurator 34 can be utilized by the link budget configurator 18 to generate link budget information 20.

The base station location determinator 16 can include a signal prediction modeler 36. The signal prediction modeler 36 can generate and update models for signal strength prediction and/or prediction of signal propagation. In some implementations, the signal prediction modeler 36 can generate models for the configuration of the particular area. For example, the signal prediction modeler 36 can generate a predictive model that accurately simulates signal strength from a simulated base station deployed to a candidate location.

Additionally, or alternatively, in some implementations, the signal prediction modeler 36 can generate a model that can be used to predict signal strength for base stations deployed to a particular type of area, such as a rural area, urban area, mixed area, indoor area, etc. To follow the depicted example, the signal prediction modeler 36 can generate rural signal prediction model 38-1, urban signal prediction model 38-2, mixed signal prediction model 38-3, and area signal prediction model 38-4 (generally, models 38). The models 38 may be utilized depending on the type of area that is being analyzed for deployment of wireless base stations. For example, if the particular area is 10 square blocks of a city, the urban signal prediction model 38-2 may be selected. For another example, if the particular area is a sparsely populated rural area, the rural signal prediction model 38-1 may be selected. For yet another example, if the signal prediction modeler 36 has access to a sufficient degree of information to generate an area signal prediction model 38-4, the area signal prediction model 38-4 can be generated and selected for use with the particular area.

The models 38 can evaluate a set of information to generate predicted signal information 40 associated with deployment of the wireless base station at the plurality of candidate locations. The set of information can include some, or all, of the information included in the base station location determinator 16, such as link budget information 20, field reporting information 22, existing base station information 24, high-resolution geographic information 30, antenna pattern allocation information 32, etc.

The predicted signal information 40 can be, or otherwise include, predicted signal strength metrics for base station deployment to the candidate locations. The predicted signal strength metrics can include a predicted signal strength and predicted interference for each location. To follow the depicted example, the predicted signal information 40 can include a predicted signal strength metric of 147 and a predicted interference metric of −0.82 dB for location 1.

The models 38 can, in some implementations, evaluate a set of information to predict interference for a particular location. The models 38 can estimate interference in the following manner:

$$Interference\_sum = [ {10}^{( \frac{neighbor \_ cell \_ 1 \_ SS}{10} )} + {10}^{( \frac{neighbor \_ cell \_ 2 \_ SS}{10} )} + {10}^{( \frac{neighbor \_ cell \_ 3 \_ SS}{10} )} + {10}^{( \frac{neighbor \_ cell \_ 4 \_ SS}{10} )} + ⋯ {10}^{( \frac{neighbor \_ cell \_ N \_ SS}{10} )} \\ Noise\_factor = - 174 + 10 * log * ( {sub}_{{carrier}_{spacing}} ) + noise\_figure \\ Signal\_to \_Noise \_Ratio = {10}^{( \frac{neighbor \_ cell \_ 1 \_ SS}{10} )} Serving\_cell \_SS - 10 * log ( interference\_sum + {10}^{\frac{noise \_ factor}{10}} ) .$$

In some implementations, the models 38 can be, or otherwise include, machine-learned models, such as neural networks, diffusion models, Multi-Layer Perceptrons (MLPs), deep learning models, Support Vector Machines (SVMs), foundational models (e.g., large-scale models trained for multiple signal prediction tasks), etc. The machine-learned models can be trained in a supervised or unsupervised fashion by the signal prediction modeler 36.

For example, the urban signal prediction model 38-2 can be utilized to generate signal strength predictions associated with deployment of the base station at a location at which a base station is already deployed. Signal strength measurements can be obtained from the deployed base station. The urban signal prediction model 38-2 can be trained based on a loss function that evaluates a difference between the signal strength measurements from the deployed base station and the signal strength predictions.

Alternatively, in some implementations, the models 38 can be statistical models or engines that can provide a prediction conditioned on available information (e.g., field reporting information 22, high-resolution geographic information 30, etc.).

The base station location determinator 16 can include signal strength measurements 42. In some implementations, the signal strength measurements 42 can include measurements taken from wireless devices within the particular area. For example, the particular area may be an area in which the first network service provider has not yet deployed base stations, but the second network service provider has deployed base stations. Because the first and second network service providers collectively operate the HMN, the computing system can obtain the signal strength measurements 42 from the second network service provider. For example, the computing system 10 can provide a signal strength measurement request 45 to the second network service provider computing system 15 via the API 28. In response, the second network service provider computing system 15 can provide the signal strength measurements 42 to the computing system 10.

Additionally, or alternatively, in some implementations, the signal strength measurements 42 can be obtained for wireless communication devices communicating with existing base stations associated with the first network service provider. For example, assume that the first network service provider has started to deploy base stations to a particular area, but has yet to complete deployment of all base stations. The signal strength measurements 42 can be obtained from wireless devices communicating with the currently deployed base stations. In this manner, the base station location determinator 16 can determine a deployment location based on the current state of the network within the area. In other words, as base stations are deployed within the particular area, the base station location determinator 16 can identify certain portions of the area that lack coverage and can select locations for deployment of subsequent base stations to remedy the lack of coverage.

The base station location determinator 16 can include a statistical analyzer 44. The statistical analyzer 44 can process predicted signal information and signal strength measurements 42 to generate a coverage maps 46. For example, assume that the predicted signal information 40 and the signal strength measurements 42 collectively provide coverage information for some portions of the particular area. The statistical analyzer 44 can extrapolate coverage information for the remaining portions of the particular area, and can utilize the extrapolated coverage information along with the predicted signal information 40 and signal strength measurements 42 to generate coverage maps 46.

To extrapolate coverage information, the statistical analyzer 44 can identify a sample measurement that is within a line-of-sight of the base station, and another sample measurement that is not within a line-of-sight with the base station. For example, assume that signal strength measurements 42 are obtained from the second network service provider computing system 15. Devices reporting to the second network service provider will generally have separate calculations due to differing configurations of frequency, bandwidth, transmission power, etc. For example, if the first network service provider is being measured for a 2 GHz frequency while the second network service provider provides a 3 GHz frequency, received measurements must be converted by frequency offset of 10*log(f_first_network_operator/f_second_network_operator). In addition, such measurements may require evaluation with reference to the second network service provider's base station locations and configuration. In some implementations, all such measurements can be aggregated and evaluated for propagation. In portions of the particular area in which no measurements have been received from either the first network service provider or the second network service provider, measurements can be based on correlation from nearby samples & line of sight measurements.

For example, a calculated free-space path loss (FSPL) signal strength can be calculated as (transmission power)−(cable loss)+(receiver antenna gain)−(FSPL) where FSPL=32.45+20*log (d in meters)+20*log (freq. in Ghz).

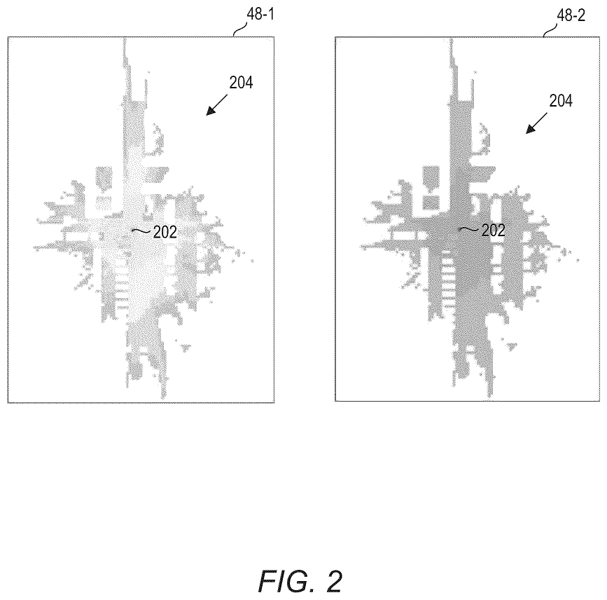

The coverage maps 48 can include signal strength coverage map 48-1 and interference coverage map 48-2. Turning to FIG. 2, FIG. 2 illustrates a signal strength coverage map 48-1 and interference coverage map 48-2 for a base station deployed to a candidate location 202 within a particular area 204 according to some implementations of the present disclosure. As depicted, the signal strength coverage map 48-1 indicates signal strength for communications between wireless devices and a base station deployed to a candidate location 202 within a particular area 204 of a city. In particular, each portion of the particular area (e.g., a city) can be represented by “pixels” of the signal strength coverage map 48-1. Each “pixel” of the signal strength coverage map 48-1 can a signal strength for signaling between by wireless devices in the portion of the area represented by the pixel and the base station deployed to the candidate location 202. The shading of the pixels can indicate relative signal strength, with lighter shades representing “stronger” signal strength. Similarly, interference coverage map 48-2 can indicate interference measured by wireless devices at each portion of the particular area. Each “pixel” of the signal strength coverage map can indicate an interference measured by wireless devices within the area represented by the pixel. The shading of the pixels can indicate relative interference levels, with darker shades representing “higher” interference.

Although the signal strength coverage map 48-1 and interference coverage map 48-2 are represented as maps that are represented on a per-pixel basis, it should be noted that the signal strength coverage map 48-1 and interference coverage map 48-2 can be, or otherwise include, tabular information that stores signal strength and interference metrics for each portion of the particular area. For example, if a grid pattern of pixels is established for the particular area, and a signal strength metric is measured, predicted, or otherwise extrapolated for each pixel in the grid, the signal strength coverage map 48-1 may store the signal strength metrics for each pixel in the grid.

In some implementations, losses associated with a wireless device being located within a building can be determined. For example, assume that a first device reports −90 dBm and a second device located adjacent to the first device reports −98 dBm. If the first device is located outside a building, and the second device is located within the building, the penetration loss can be calculated as 8 dBm. Such losses can be applied to rest of the area in order to calculate indoor propagation and interference can be calculated accordingly.

Returning to FIG. 1, the base station location determinator 16 can include a location selector 50. The location selector 50 can be a collection of hardware and/or software resources that selects a particular candidate location of the plurality of candidate locations. In particular, the location selector 50 can make a decision between the plurality of candidate locations to select an optimal candidate location.

In some implementations, the location selector 50 can select a candidate location based on a variety of factors, including deployment cost, predicted increases in coverage and signal strength, predicted number of affected customers, required resources, etc. For example, assume that base station deployment to a first candidate location is likely to provide a greater overall increase in signal strength, or coverage, for the particular area than a second candidate location. The location selector 50 may select the first candidate location due to the greater increase in signal strength in comparison to the second candidate location. However, if the increase in signal strength from deployment to the first candidate location is largely concentrated in sparsely populated areas, while the increase in signal strength from deployment to the second candidate location is largely concentrated in densely populated areas, the location selector 50 may select the second candidate location so as to increase transmission quality for a greater number of subscribers to the first network service provider.

To follow the previous example, further assume that the deployment costs for the second candidate location are substantially higher than the deployment costs of the first candidate location. For example, if the second candidate location is a skyscraper owned by a third party, the costs associated with securing deployment rights for the skyscraper may be prohibitively expensive. Based on the deployment costs, the location selector 50 may instead select the first candidate location rather than the second candidate location.

It should be noted that the location selector 50 can leverage any of the information available to the base station location determinator 16 to select a candidate location for base station deployment. To follow the previous example, further assume that the high-resolution geographic information 30 indicates that building plans have recently been approved for a skyscraper positioned directly adjacent to the first candidate location. Due to the likelihood that the planned skyscraper will substantially reduce the signal strength of a base station deployed to the first candidate location in the future, the location selector 50 may instead select the second candidate location for base station deployment.

In some implementations, the location selector 50 can generate selection information 52. The selection information 52 can include a location (e.g., latitude/longitude coordinates), a deployment height, a deployment angle, a deployment cost, a resource allocation request, predicted signal strength or coverage increases, predicted interference, or any other variables, metrics, etc. evaluated, determined, obtained, or otherwise accessed by the location selector 50. The base station location determinator 16 can provide the selection information 52 to some other entity. For example, the base station location determinator 16 may provide the selection information 52 to a third party that is responsible for deploying base stations within the particular area.

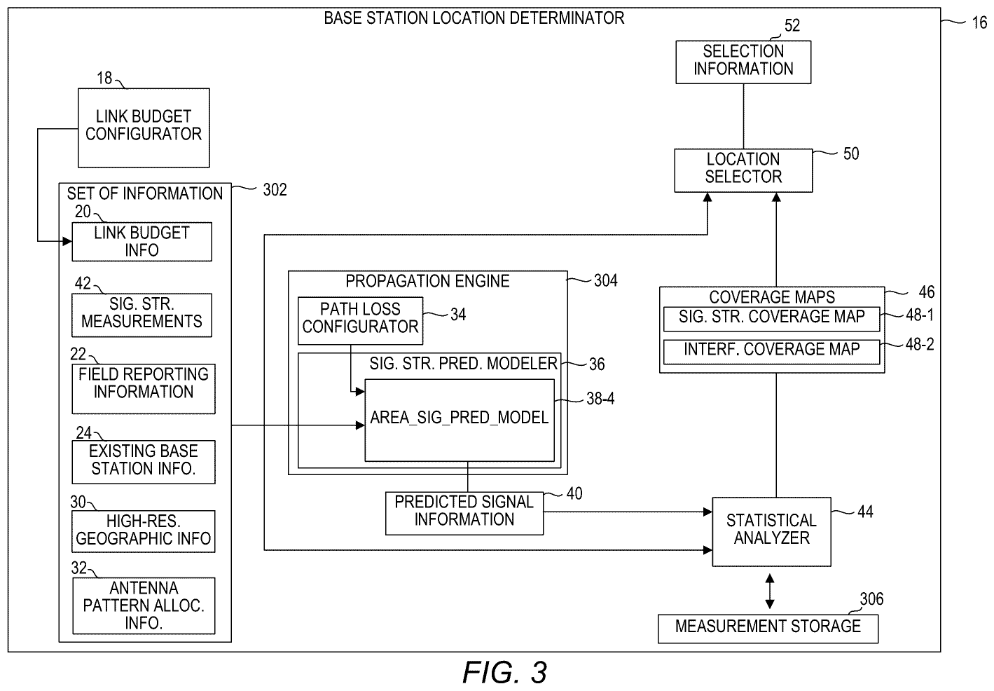

FIG. 3 is a data flow diagram for leveraging the base station location determinator 16 of FIG. 1 to perform autonomous selection of base station deployment locations according to some implementations of the present disclosure. As described with regards to FIG. 1, the base station location determinator 16 can include link budget configurator 18, which can generate link budget information 20. The base station location determinator 16 can also include signal strength measurements 42, field reporting information 22, existing base station information 24, high-resolution geographic information 30, and antenna pattern allocation information 32.

A set of information 302 can be provided to a propagation engine 304 for evaluation. The set of information 302 can include some (or all) of the information available to the base station location determinator 16. For example, the set of information 302 can include the link budget information 20, signal strength measurements 42, field reporting information 22, existing base station information 24, high-resolution geographic information 30, and/or antenna pattern allocation information 32.

The propagation engine 304 can be a collection of software and/or hardware resources that implement an automated build process to produce signal strength predictions based on multiple factors. The propagation engine 304 can be enhanced to accommodate for multiple parameters, such as receiver height, clutter characteristics, transmitter heights, device speed, reflection and refraction coefficient, etc.

In some implementations, the propagation engine 304 can include the signal prediction modeler 36. The signal prediction modeler 36 can maintain the area signal prediction model 38-4 for the particular area (e.g., area 204 of FIG. 2, etc.). The area signal prediction model 38-4 can evaluate (i.e., process) the set of information 302 to obtain predicted signal information 40.

In some implementations, the path loss configurator 324 can provide configuration information to the area signal prediction model 38-4. The configuration information can indicate a configuration for the base station if deployed to the candidate location.

The statistical analyzer 44 can evaluate the predicted signal information 40 and, in some implementations, at least some of the set of information 302 to obtain coverage maps 46. In some implementations, the statistical analyzer 44 can store and/or retrieve information from the measurement storage 306. The measurement storage 306 can store reported measurements from existing devices based on a current footprint. The measurement storage 306 can also store reported measurements from other network service providers so that the first network service provider can be aware that there is coverage being provided from the second network service provider and not the first network service provider. Upon deployment of a base station using the various implementations of the present disclosure, the measurement storage 306 can record measurements made for communications between the deployed base station and wireless devices.

The coverage maps 46, and, in some implementations, at least some of the set of information 302, can be processed with the location selector 50 to generate selection information 52. In such fashion, the base station location determinator 16 can autonomously perform autonomous selection of base station deployment locations.

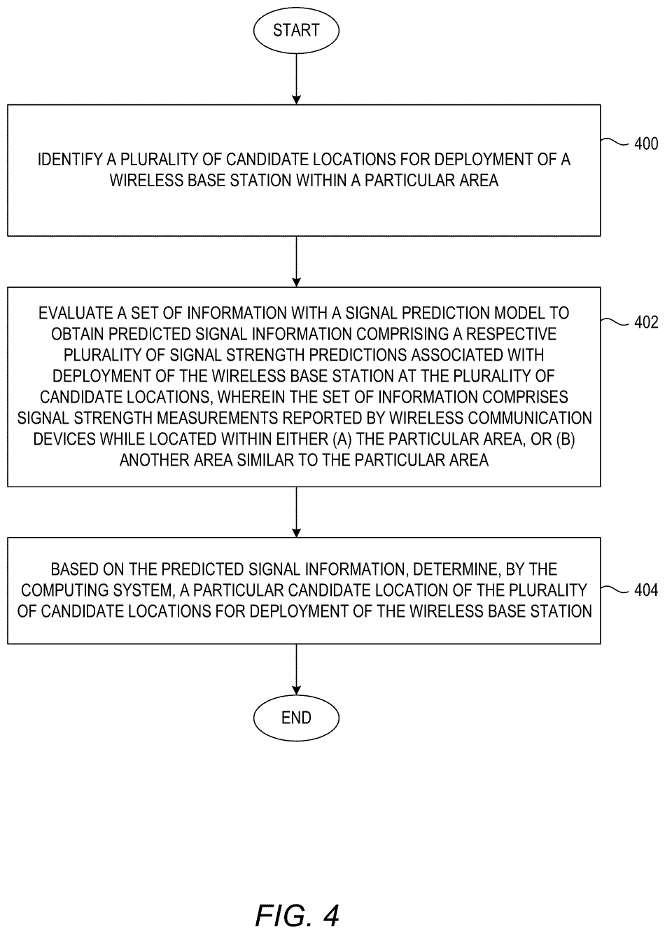

FIG. 4 is a flowchart of a method for autonomous selection of base station deployment locations according to some implementations of the present disclosure. FIG. 4 will be discussed in conjunction with FIGS. 1, 2, and 3.

The computing system 10 identifies a plurality of candidate locations 202 (e.g., as identified by field reporting information 22, etc.) for deployment of a wireless base station within a particular area 204 (FIG. 4, block 400). The computing system 10 evaluates a set of information 302 with a signal prediction model 38-4 to obtain predicted signal information 40 that includes a respective plurality of signal strength predictions associated with deployment of the wireless base station at the plurality of candidate locations 202, wherein the set of information 302 includes signal strength measurements 42 reported by wireless devices located within either (a) the particular area 204 or (b) another area similar to the particular area 204 (FIG. 4, block 402). Based on the predicted signal information 40, the computing system 10 determines a particular candidate location (e.g., as indicated by selection information 52) of the plurality of candidate locations for deployment of the wireless base station (FIG. 4, block 404).

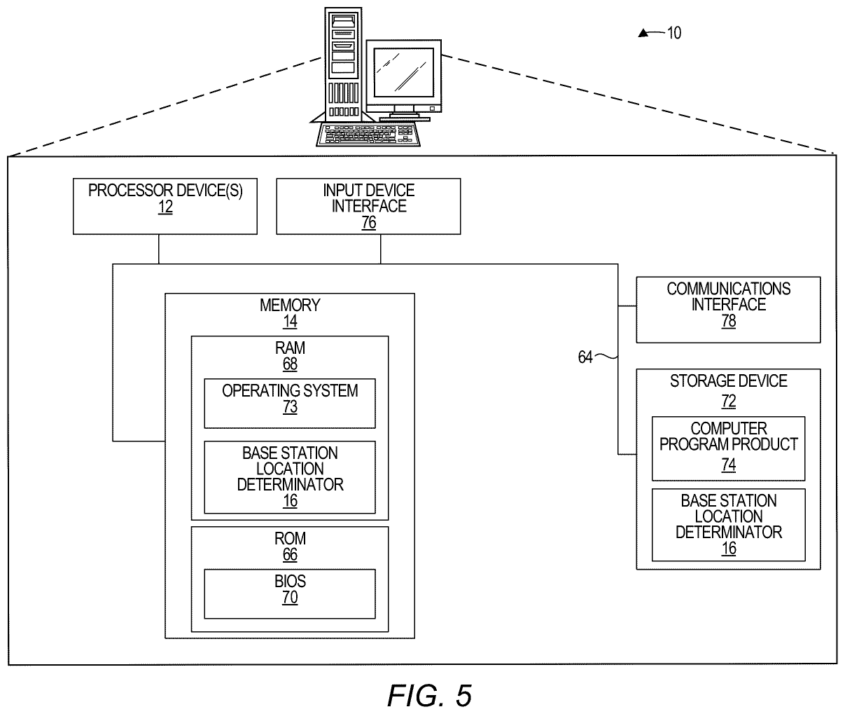

FIG. 5 is a block diagram of the computing system 10 suitable for implementing examples according to one example. The computing system 10 may comprise any computing or electronic device capable of including firmware, hardware, and/or executing software instructions to implement the functionality described herein, such as a computer server, a desktop computing device, a laptop computing device, a smartphone, a computing tablet, or the like. The computing system 10 includes the processor device(s) 12, the memory 14, and a system bus 64. The system bus 64 provides an interface for system components including, but not limited to, the memory 14 and the processor device(s) 12. The processor device(s) 12 can be any commercially available or proprietary processor.

The system bus 64 may be any of several types of bus structures that may further interconnect to a memory bus (with or without a memory controller), a peripheral bus, and/or a local bus using any of a variety of commercially available bus architectures. The memory 14 may include non-volatile memory 66 (e.g., read-only memory (ROM), erasable programmable read-only memory (EPROM), electrically erasable programmable read-only memory (EEPROM), etc.), and volatile memory 68 (e.g., random-access memory (RAM)). A basic input/output system (BIOS) 70 may be stored in the non-volatile memory 66 and can include the basic routines that help to transfer information between elements within the computing system 10. The volatile memory 68 may also include a high-speed RAM, such as static RAM, for caching data.

The computing system 10 may further include or be coupled to a non-transitory computer-readable storage medium such as the storage device 72, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 72 and other drives associated with computer-readable media and computer-usable media may provide non-volatile storage of data, data structures, computer-executable instructions, and the like.

A number of modules can be stored in the storage device 72 and in the volatile memory 68, including an operating system 73 and one or more program modules, such as the base station location determinator 16, which may implement the functionality described herein in whole or in part. All or a portion of the examples may be implemented as a computer program product 74 stored on a transitory or non-transitory computer-usable or computer-readable storage medium, such as the storage device 72, which includes complex programming instructions, such as complex computer-readable program code, to cause the processor device(s) 12 to carry out the steps described herein. Thus, the computer-readable program code can comprise software instructions for implementing the functionality of the examples described herein when executed on the processor device(s) 12. The processor device(s) 12, in conjunction with the base station location determinator 16 in the volatile memory 68, may serve as a controller, or control system, for the computing system 10 that is to implement the functionality described herein.

Because the base station location determinator 16 is a component of the computing system 10, functionality implemented by the base station location determinator 16 may be attributed to the computing system 10 generally.

Moreover, in examples where the base station location determinator 16 comprises software instructions that program the processor device(s) 12 to carry out functionality discussed herein, functionality implemented by the base station location determinator 16 may be attributed herein to the processor device(s) 12.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 12 through an input device interface 76 that is coupled to the system bus 64 but can be connected by other interfaces such as a parallel port, an Institute of Electrical and Electronic Engineers (IEEE) 1394 serial port, a Universal Serial Bus (USB) port, an IR interface, and the like. The computing system 10 may also include a communications interface 78 suitable for communicating with a network as appropriate or desired. The computing system 10 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising,
identifying, by a computing system comprising one or more processor devices, a plurality of candidate locations for deployment of a wireless base station within a particular area;
evaluating, by the computing system, a set of information with a signal prediction model to obtain predicted signal information comprising a respective plurality of signal strength predictions associated with deployment of the wireless base station at the plurality of candidate locations, wherein the set of information comprises signal strength measurements reported by wireless devices while located within either:
(a) the particular area; or
(b) another area similar to the particular area; and
based on the predicted signal information, determining, by the computing system, a particular candidate location of the plurality of candidate locations for deployment of the wireless base station.

2. The method of claim 1, wherein evaluating the set of information with the signal prediction model to obtain the predicted signal information comprises:
generating, by the computing system, the signal prediction model based at least in part on high-resolution geographic information for the area, wherein the high-resolution geographic information is descriptive of terrain within the area and dimensions for buildings located within the area.

3. The method of claim 2, wherein evaluating the set of information with the signal prediction model to obtain the predicted signal information comprises:
processing, by the computing system, the set of information with the signal prediction model to obtain the predicted signal information, wherein the predicted signal information comprises, for each of the plurality of candidate locations:
a predicted signal strength map indicative of a predicted signal strength for signaling received at each portion of a map of the particular area from a wireless base station deployed at the candidate location; and
a predicted interference map indicative of a predicted interference for signaling received at each portion of the map of the particular area from the wireless base station deployed at the candidate location.

4. The method of claim 3, wherein processing the set of information with the signal prediction model further comprises:
for each of the plurality of candidate locations, determining, by the computing system, an estimated value associated with deployment of the wireless base station to the candidate location, wherein the estimated value is based at least in part on the predicted signal information for the candidate location and a cost associated with deployment of the wireless base station to the candidate location.

5. The method of claim 4, wherein determining the particular candidate location of the plurality of candidate locations for the deployment of the wireless base station comprises:
determining, by the computing system, the particular candidate location based on the estimated value associated with deployment of the wireless base station at the particular candidate location being higher than the estimated value associated with deployment of the wireless base station at any other candidate location.

6. The method of claim 1, wherein, prior to evaluating the set of information, the method comprises:
obtaining, by the computing system, base station configuration information for one or more existing wireless base stations within the particular area; and
wherein the set of information further comprises the base station configuration information.

7. The method of claim 6, wherein identifying the plurality of candidate locations comprises identifying, by the computing system, the plurality of candidate locations for deployment of a wireless base station by a first network service provider within the particular area.

8. The method of claim 7, wherein obtaining the base station configuration information for the one or more existing wireless base stations comprises obtaining first base station configuration information for a first existing wireless base station, wherein the first existing wireless base station is associated with the first network service provider.

9. The method of claim 8, wherein obtaining the first base station configuration information for the first existing wireless base station further comprises obtaining, by the computing system, second base station configuration information for a second existing wireless base station, wherein the second existing wireless base station is associated with a second network service provider different than the first network service provider.

10. The method of claim 7, wherein, prior to evaluating the set of information, the method comprises:
obtaining, by the computing system, information indicative of a link budget for network services provided in the first network service provider within the particular area; and
wherein the set of information further comprises the information indicative of the link budget for the network services provided by the first network service provider within the particular area.

11. The method of claim 10, wherein obtaining the information indicative of the link budget for the network services provided by the first network service provider within the particular area comprises:
determining, by the computing system, the information indicative of the link budget for the network services provided by the first network service provider within the particular area based at least in part on at least one of:
an estimated transmit power of the wireless base station;
a minimum receiver signal strength;
an estimated transmit power for wireless devices within the particular area;
an estimated downlink path loss; or
an estimated uplink path loss.

12. The method of claim 1, wherein identifying the plurality of candidate locations for deployment of the wireless base station within a particular area comprises:
obtaining, by the computing system, field reporting information, wherein, for each of the plurality of candidate locations, the field reporting information is descriptive of at least one of:
an available angle or azimuth for the wireless base station at the candidate location;
an installation height for the wireless base station at the candidate location; or
coordinates for the candidate location; and
wherein the set of information comprises the field reporting information.

13. The method of claim 1, wherein the method further comprises:
obtaining, by the computing system, signal strength measurements for signaling received by wireless devices from a wireless base station deployed at the particular candidate location; and
updating, by the computing system, the signal prediction model based on a difference between the signal strength measurements and the predicted signal information.

14. A computing system comprising:
a memory; and
one or more processor devices coupled to the memory to:
identify a plurality of candidate locations for deployment of a wireless base station within a particular area;
evaluate a set of information with a signal prediction model to obtain predicted signal information comprising a respective plurality of signal strength predictions associated with deployment of the wireless base station at the plurality of candidate locations, wherein the set of information comprises signal strength measurements reported by wireless devices while located within either:
(a) the particular area; or
(b) another area similar to the particular area; and
based on the predicted signal information, determine a particular candidate location of the plurality of candidate locations for deployment of the wireless base station.

15. The computing system of claim 14, wherein evaluating the set of information with the signal prediction model to obtain the predicted signal information comprises:
generating the signal prediction model based at least in part on high-resolution geographic information for the area, wherein the high-resolution geographic information is descriptive of terrain within the area and dimensions for buildings located within the area.

16. The computing system of claim 15, wherein evaluating the set of information with the signal prediction model to obtain the predicted signal information comprises:
processing the set of information with the signal prediction model to obtain the predicted signal information, wherein the predicted signal information comprises, for each of the plurality of candidate locations:
a predicted signal strength map indicative of a predicted signal strength for signaling received at each portion of a map of the particular area from a wireless base station deployed at the candidate location; and
a predicted interference map indicative of a predicted interference for signaling received at each portion of the map of the particular area from the wireless base station deployed at the candidate location.

17. The computing system of claim 16, wherein processing the set of information with the signal prediction model further comprises:
for each of the plurality of candidate locations, determining an estimated value associated with deployment of the wireless base station to the candidate location, wherein the estimated value is based at least in part on the predicted signal information for the candidate location and a cost associated with deployment of the wireless base station to the candidate location.

18. The computing system of claim 17, wherein determining the particular candidate location of the plurality of candidate locations for the deployment of the wireless base station comprises:
determining the particular candidate location based on the estimated value associated with deployment of the wireless base station at the particular candidate location being higher than the estimated value associated with deployment of the wireless base station at any other candidate location.

19. The computing system of claim 14, wherein, prior to evaluating the set of information, the one or more processor devices are to:
obtain base station configuration information for one or more existing wireless base stations within the particular area; and
wherein the set of information further comprises the base station configuration information.

20. A non-transitory computer-readable storage medium that includes executable instructions to cause one or more processor devices to:
identify a plurality of candidate locations for deployment of a wireless base station within a particular area;
evaluate a set of information with a signal prediction model to obtain predicted signal information comprising a respective plurality of signal strength predictions associated with deployment of the wireless base station at the plurality of candidate locations, wherein the set of information comprises signal strength measurements reported by wireless devices while located within either:
(a) the particular area; or
(b) another area similar to the particular area; and
based on the predicted signal information, determine a particular candidate location of the plurality of candidate locations for deployment of the wireless base station.
